(19) United States
(12) Patent Application Publication
(10) Pub. No.: US 2015/0097061 A1
(43) Pub. Date: Apr. 9, 2015

(54) DISC CENTRIFUGE NOZZLE

(71) Applicants: SYNCRUDE CANADA LTD. in trust for the owners of the Syncrude Project, as such owners exist now and, Fort McMurray (CA); ALFA LAVAL CORPORATE AB, Lund (SE)

(72) Inventors: KEVIN REID, Edmonton (CA); DANIEL BULBUC, Fort McMurray (CA); OLLE TÖRNBLOM, Tullinge (SE); JIE ZHENG, Solna (SE)

(21) Appl. No.: 14/505,962

(22) Filed: Oct. 3, 2014

Related U.S. Application Data
(60) Provisional application No. 61/886,823, filed on Oct. 4, 2013.

(51) Int. Cl. B04B 1/10

(52) U.S. Cl. CPC B04B 1/10
USPC 239/589

(57) ABSTRACT

A nozzle for use in the bowl of a disc centrifuge is provided, comprising an inner sleeve forming a longitudinally extending passageway, the inner sleeve having an elevated region at its top, the elevated region having an extended front end; and an outer sleeve for supporting the inner sleeve along most of its length, the outer sleeve having a collar with an outermost edge at its top; whereby when the inner sleeve is inserted into the outer sleeve, the elevated region of the inner sleeve extends past the collar of the outer sleeve and the extended front end of the elevated region extends towards the outermost edge of the outer sleeve collar.

### FIELD OF THE INVENTION

The present invention relates generally to a modified external nozzle design for use in the outlet of a bowl of a disc centrifuge that reduces wear on the top surface of the nozzles.

### BACKGROUND OF THE INVENTION

Centrifugal machines of a nozzle type typically include a rotor or rotating bowl defining a separating chamber containing a stack of separating discs for effecting a two-fraction separation of a feed slurry. The feed slurry is separated into a heavy discharge slurry, or underflow fraction, which is delivered outside the rotor by a plurality of nozzles supported within the outer wall of the rotor. Generally, the plurality of nozzles are circumferentially positioned around the outermost periphery of the rotor. Each nozzle includes an inlet portion in communication with an interior area defined by the rotor bowl and an outlet to allow separated material to escape from the rotor bowl. A light fraction or separated liquid is removed from the rotor by overflow from the top end of the machine.

In the oil sands industry, disc centrifuges are commonly used for de-sanding bitumen froth recovered from oil sands using a hot or warm water-based extraction process. Typically, bitumen froth comprises about 60% bitumen, 30% solids and 10% water. The bitumen froth is diluted with a solvent, such as naphtha solvent, followed by bitumen separation in a sequence of scroll and disc centrifuges. The inertial forces of the disc centrifuges cause water and solids to migrate outwardly towards the spinning bowl wall. The bitumen works its way inwardly and accumulates near the center of the disc stack, where it is removed as the light phase discharge. Thus, the water and the solids are discharged from the bowl through the plurality of nozzles, which are fitted into apertures formed in the bowl wall.

Hence, in service, the nozzles are subject to high wear rates, both internally, i.e., the nozzle bore, and externally, i.e., the sleeve which enveloped the passageway or bore of the nozzle. This leads to significant replacement and repair costs. Canadian Patent No. 2,084,974 addresses the issue of internal erosion by modifying the longitudinal bore, which generally comprises two straight segments joined by an elbow, by having the surface of the bore smoothly curved and continuous through the change of direction (i.e., elbow), to prevent the eddying associated with change-of-angle linear junctions of the segments, thereby altering the flow pattern of the stream with a significant reduction in wear.

As shown herein in FIG. 1, labeled Prior Art, the nozzle 1 of Canadian Patent No. 2,084,974, owned by the present applicant, comprises a duplex body formed by an inner sleeve 3 having a top surface 9 and a contiguous outer sleeve 4 having a protruding collar 14. The outer sleeve 4 forms a sheath which supports the inner sleeve 3 along most of its length. Typically, the inner sleeve is formed of titanium carbide and the outer sleeve 4 of stainless steel. The inner sleeve 3 forms an internal longitudinal bore 5 comprising an inlet segment 6 and an outlet segment 7 joined by an elbow segment 8. The surface of the elbow segment 8 is curved and smooth, being free of linear junction lines at the joinder of bore surfaces disposed at different angles.

However, it was discovered that the nozzle in FIG. 1 still showed considerable wear at the top 9 of inner sleeve 3. The present invention addresses this issue of external erosion of disc centrifuge nozzles, in particular, at the top 9 of inner sleeve 3.

### SUMMARY OF THE INVENTION

The present applicant used fluid dynamic modeling, e.g., Computational Fluid Dynamics or CFD, to study wear patterns on the outer surface of nozzles routinely used in disc centrifuges. Initially, it was believed that erosion problems at the top of the inner sleeve of the nozzles could be remedied simply by extending (i.e., thickening) the top of the inner sleeve to produce a nozzle having a raised or elevated portion with a blunted nose at the front end. Hence, the inner sleeve could still fit into the outer sleeve, however, it would now have an elevated region.

However, it was discovered that such nozzles were still having significant erosion problems and a horse shoe-like wear pattern was observed. Such wear pattern was confirmed with the use of CFD, where stagnation was observed due to the blunted nose and the formation of a horse shoe vortex was also observed in this region. It was surprisingly discovered that by tapering the front (i.e., eliminating the blunted nose) of the elevated region of the inner sleeve to form a more wedge shaped front end (a tapered front end), i.e., making it more streamlined, the external wear of these nozzles greatly improved, as the horse shoe eddies and the like were substantially reduced.

Without being bound to theory, it is believed that having a sharp transition point between the inner sleeve and the outer sleeve of the nozzle (e.g., such as a 90° transition point) causes excessive wear at that point due to the production of various eddies, such as horseshoe eddies.

Thus, broadly stated, in one aspect of the invention, a nozzle for use in the bowl of a disc centrifuge is provided, comprising:
an inner sleeve forming a longitudinally extending passageway, the inner sleeve having an elevated region at its top, the elevated region having an extended front end; and
an outer sleeve for supporting the inner sleeve along most of its length, the outer sleeve having a collar with an outermost edge at its top;
whereby when the inner sleeve is inserted into the outer sleeve, the elevated region of the inner sleeve extends past the collar of the outer sleeve and the extended front end of the elevated region extends towards the outermost edge of the outer sleeve collar.

### DESCRIPTION OF THE DRAWINGS

Referring to the drawings wherein like reference numerals indicate similar parts throughout the several views, several aspects of the present invention are illustrated by way of example, and not by way of limitation, in detail in the figures, wherein:

FIG. 1 is a cross-sectional view of a prior embodiment of a disc centrifuge nozzle.

FIG. 2 is a cross-sectional view of the nozzle of FIG. 1 where the inner sleeve has an elevated region at its top with a blunted nose at its front end.

FIG. 3 is a cross-sectional view of the nozzle of FIG. 2 where the inner sleeve has an elevated region at its top with a tapered wedge shaped front end.

FIG. 4 is a perspective view of the elevated region of the nozzle in FIG. 2.

FIG. 5 is a perspective view of the elevated region of the nozzle in FIG. 3.

FIG. 6A is a perspective front view of the inner sleeve of the nozzle in FIG. 3.

FIG. 6B is a perspective side view of the inner sleeve of the nozzle in FIG. 3.

FIG. 6C is a perspective top view of the inner sleeve of the nozzle in FIG. 3.

FIG. 7 shows the velocity magnitude in rotating frame of a nozzle having a blunted cap (Panel A) and a nozzle having a streamlined cap (Panel B).

FIG. 8 shows the wall shear stress distribution on rotating parts for a nozzle having a blunted cap (Panel A) and a nozzle having a streamlined cap (Panel B).

FIG. 9 shows the swirl in y-direction (flow direction) for a nozzle having a blunted cap (Panel A) and a nozzle having a streamlined cap (Panel B).

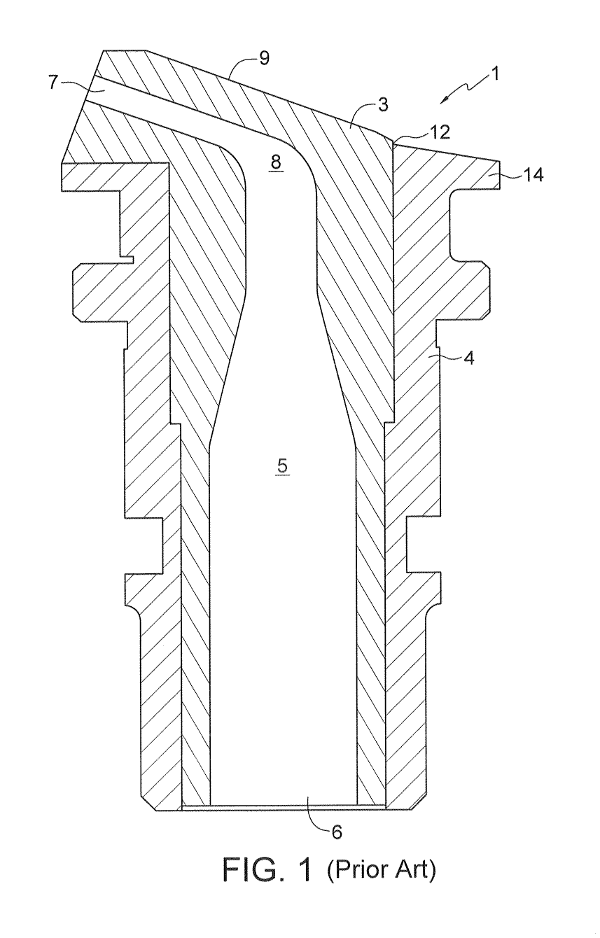

### DESCRIPTION OF THE PREFERRED EMBODIMENT

The detailed description set forth below in connection with the appended drawing is intended as a description of various embodiments of the present invention and is not intended to represent the only embodiments contemplated by the inventor. The detailed description includes specific details for the purpose of providing a comprehensive understanding of the present invention. However, it will be apparent to those skilled in the art that the present invention may be practiced without these specific details.

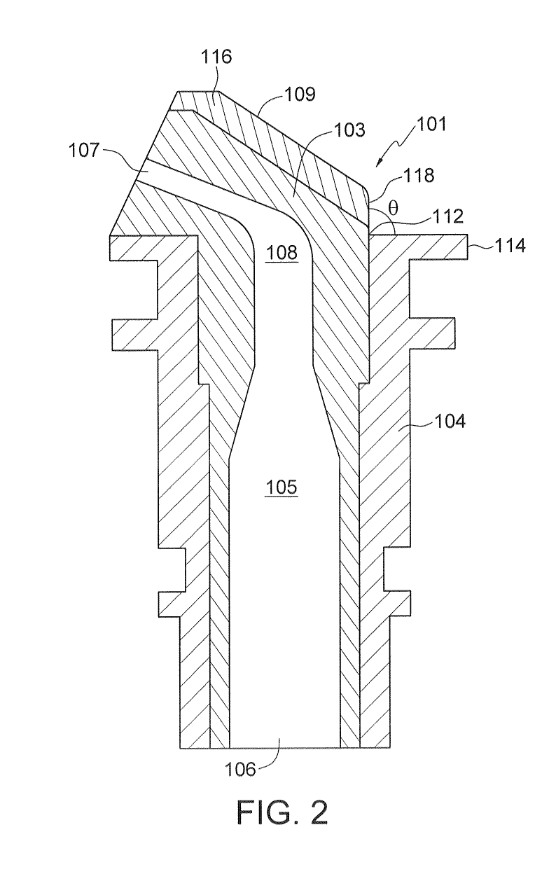

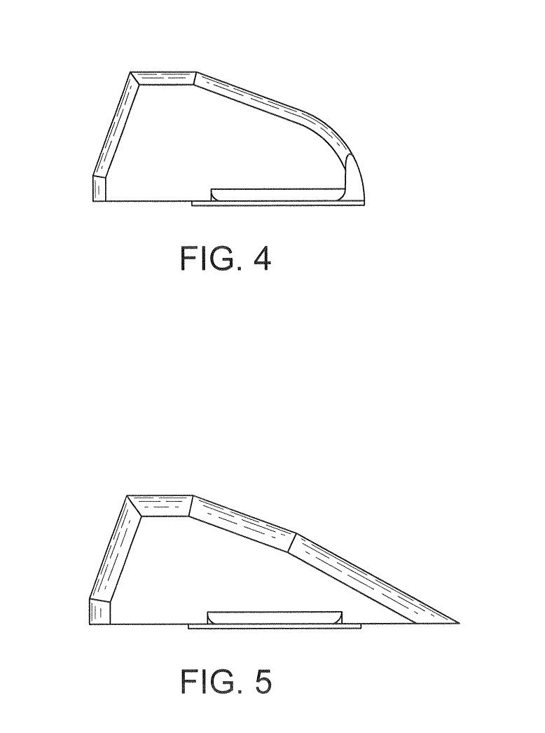

With reference to FIG. 2, nozzle 101 comprises a duplex body formed by an inner sleeve 103 having a top surface 109, the inner sleeve further comprising an elevated region or cap 116 at its top for further wear protection. Nozzle 101 further comprises a contiguous outer sleeve 104 having a protruding collar 114. The outer sleeve 104 forms a sheath which supports the inner sleeve 103 along most of its length so that the elevated region or cap 116 of inner sleeve 103 protrudes from outer sleeve 104. In one embodiment, cap 116 is made from the same material as inner sleeve 103 and generally cap 116 and inner sleeve 103 are formed as a unitary body. Typically, the inner sleeve 103 is formed of titanium carbide and the outer sleeve 104 of stainless steel. Cap 116 further comprises a front snubbed or blunted nose 118. The snubbed nose 118 at the front end can be seen in a perspective view in FIG. 4.

The inner sleeve 103 forms an internal longitudinal bore 105 comprising an inlet segment 106 and an outlet segment 107 joined by an elbow segment 108. The surface of the elbow segment 108 is curved and smooth, being free of linear junction lines at the joinder of bore surfaces disposed at different angles.

However, it was discovered that the nozzle in FIG. 2 still showed considerable wear, in particular, at the junction 112 of inner sleeve 103 and outer sleeve 104. The extended collar 114 and the snubbed nose 118 formed an angle (θ) of about 90° and formed a substantial step down from the top surface 109 of cap 116 and the top surface of extended collar 114. It was observed that there was a horse-shoe wear pattern that developed at the top 109 of inner sleeve 103.

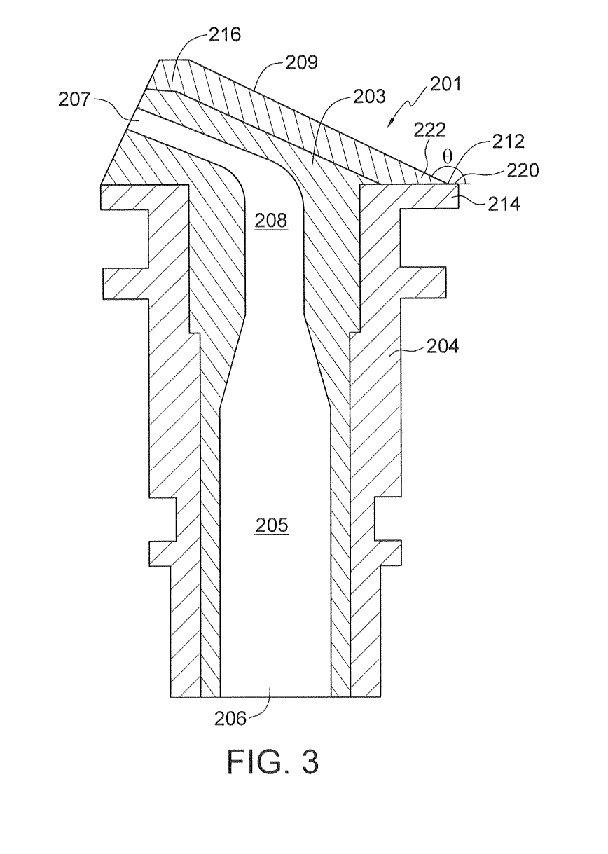

The present invention addresses this issue of external erosion of disc centrifuge nozzles, in particular, at the top 109 of inner sleeve 103. An embodiment of the present invention is shown in FIG. 3. In FIG. 3, nozzle 201 comprises a duplex body formed by an inner sleeve 203 having a top surface 209, the inner sleeve 203 further comprising an elevated region or cap 216 at its top for further wear protection. Nozzle 201 further comprises a contiguous outer sleeve 204 having a protruding collar 214. The outer sleeve 204 forms a sheath which supports the inner sleeve 203 along most of its length so that the elevated region or cap 216 of inner sleeve 203 protrudes from outer sleeve 204. In one embodiment, cap 216 is made from the same material as inner sleeve 203 and generally cap 216 and inner sleeve 203 are formed as a unitary body. Typically, the inner sleeve 203 is formed of titanium carbide and the outer sleeve 204 of stainless steel. Cap 216 further comprises an extended front end 222, forming a tapered wedge shaped front end. The extended wedge shaped front end 222 can be seen in a perspective view in FIG. 5. The front end 222 covers a substantial portion of the collar 214; however, preferably, a portion 220 of the outer sleeve collar 214 upstream of the front end 222 remains uncovered to ensure wear occurs on the nozzle and not the bowl of the disc centrifuge.

The inner sleeve 203 forms an internal longitudinal bore 205 comprising an inlet segment 206 and an outlet segment 207 joined by an elbow segment 208. The surface of the elbow segment 208 is curved and smooth, being free of linear junction lines at the joinder of bore surfaces disposed at different angles.

It was discovered that the nozzle in FIG. 3 showed considerably reduced wear, in particular, at the junction 212 of inner sleeve 203 and outer sleeve 204. The outer sleeve collar 214 and the extended front end 222 are secured to one another so that there is no space between the two parts. Further, the angle (θ) is much greater than 90°, e.g., in this embodiment around 150°, and substantially no step down is seen from the top surface 209 of cap 216 and the top surface of extended collar 214. Thus, it was observed that there was little or no horse-shoe wear pattern that developed at the top 209 of inner sleeve 203.

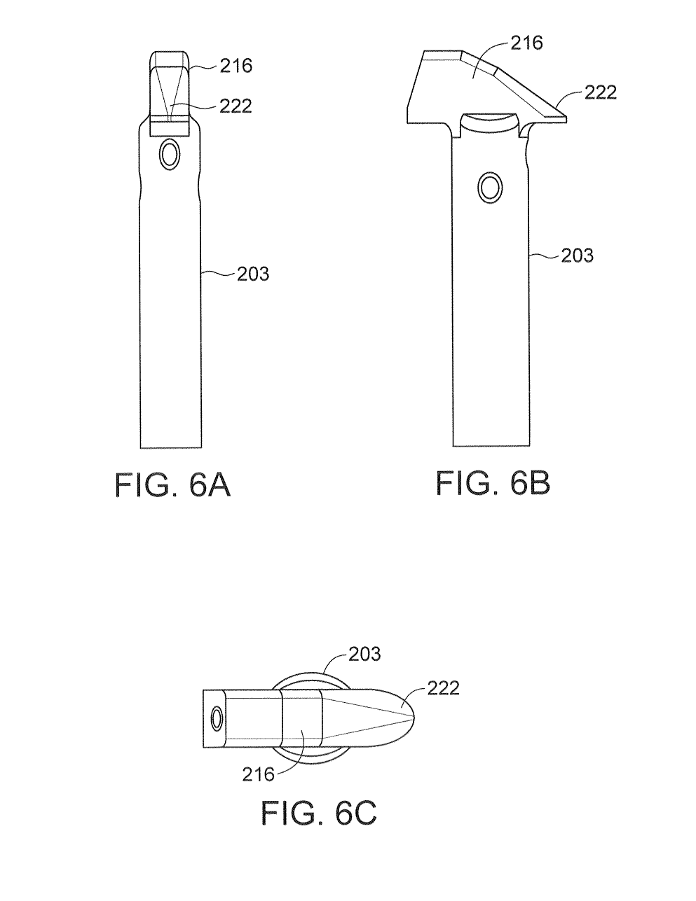

The inner sleeve 203 is shown in three perspective views in FIG. 6. In particular, FIG. 6A shows the inner sleeve 203 looking towards the front end 222 of cap 216. FIG. 6B shows inner sleeve 203 from the side which shows the extended rounded front end 222. FIG. 6C shows inner sleeve 203 looking down on cap 216 and shows the extended rounded

### EXAMPLE 1

Computational fluid dynamics, usually abbreviated as CFO, is a branch of fluid mechanics that uses numerical methods and algorithms to solve and analyze problems that involve fluid flows. Computers are used to perform the calculations required to simulate the interaction of liquids and gases with surfaces defined by boundary conditions. Ongoing research yields software that improves the accuracy and speed of complex simulation scenarios such as transonic or turbulent flows.

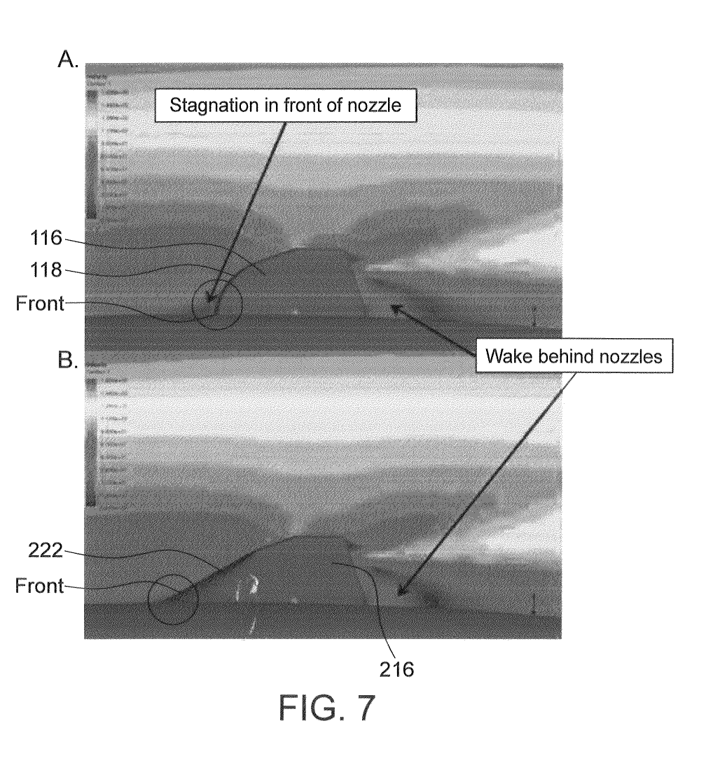

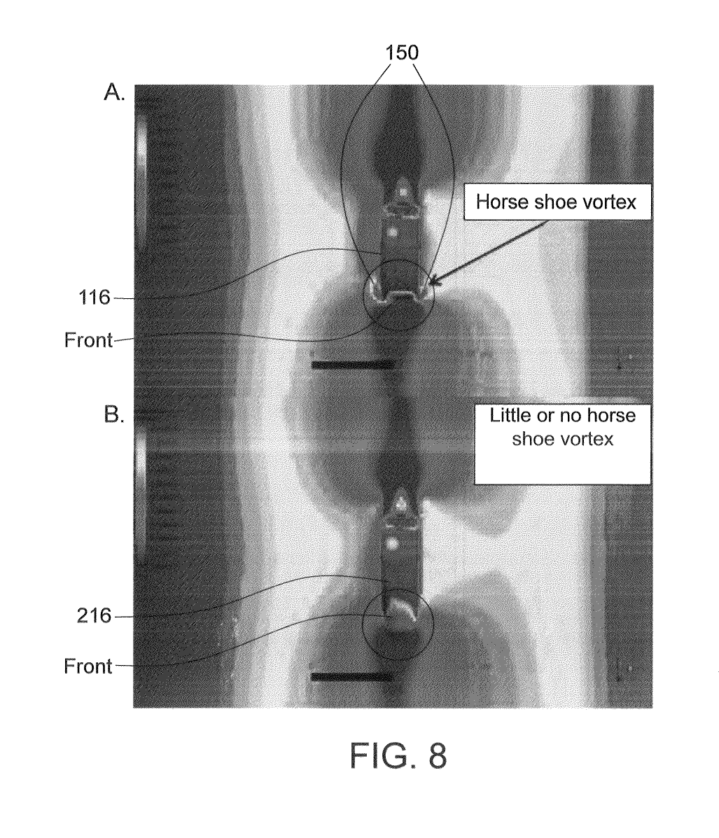

CFD was used to test nozzles 101 and 201, as shown in FIG. 2 and FIG. 3, respectively, and having caps 116 and 216, respectively. FIG. 7 shows the velocity magnitude in rotating frame of a nozzle having a blunted cap 116 (Panel A) and a nozzle having a streamlined cap 216 (Panel B). It can be seen that when the front of the nozzle cap is blunted, as in Panel A, there is stagnation in front of the nozzle (circle). However, when the front of the nozzle cap is extended and streamlined, as in Panel B, there is little or no stagnation in front of the nozzle (circle).

FIG. 8 shows the wall shear stress distribution on rotating parts for a nozzle having a blunted cap 116 (Panel A) and a nozzle having a streamlined cap 216 (Panel B). Essentially, the radial velocity was analyzed 1 mm outside the bowl wall. It can be seen that when the front of the nozzle cap is blunted, as in Panel A, a horse shoe vortex 150 was observed (circle). However, when the front of the nozzle cap was extended and streamlined, as in Panel B, little or no horse shoe vortex was observed (circle).

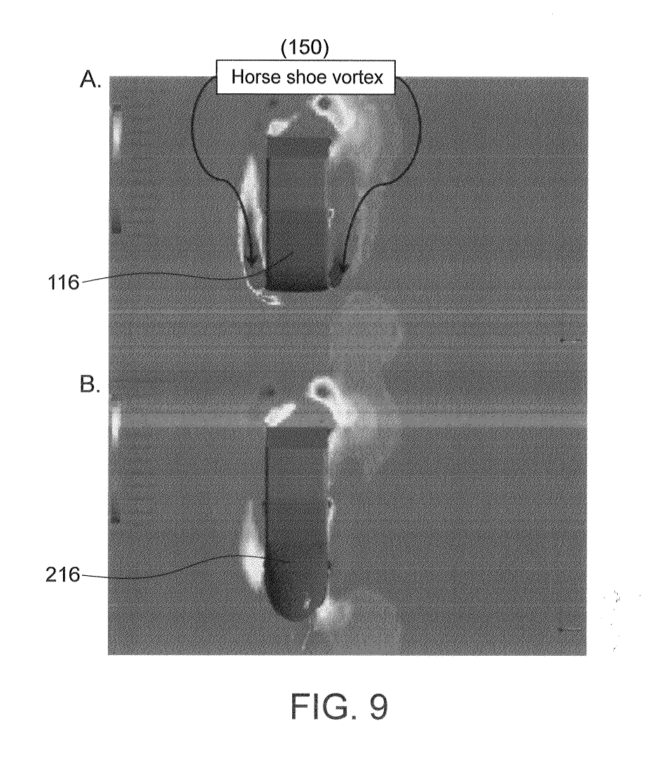

FIG. 9 shows the swirl in y-direction (flow direction) for a nozzle having a blunted cap 116 (Panel A) and a nozzle having a streamlined cap 216 (Panel B). Essentially, the vortex strength was analyzed 1 mm outside the bowl wall. It can be seen that when the front of the nozzle cap is blunted, as in Panel A, a horse shoe vortex 150 was also observed. However, when the front of the nozzle cap was extended and streamlined, as in Panel B, little or no horse shoe vortex was observed.

Thus, it was observed that the elevated (above bowl surface) stagnation region responsible for the horse shoe vortex of the nozzle of FIG. 2 could be corrected, i.e., substantially removed, by the addition of a more wedge shaped front end. This change in geometry reduced/eliminated the horse shoe vortex and, hence, the horse shoe vortex wear pattern. Thus, a nozzle with an extended and rounded front end on its inner sleeve cap will have less erosion on the top of the inner sleeve and therefore a greater life span.

From the foregoing description, one skilled in the art can easily ascertain the essential characteristics of this invention. However, the scope of the claims should not be limited by the preferred embodiments set forth in the examples, but should be given the broadest interpretation consistent with the description as a whole.

What is claimed:

1. A nozzle for use in a bowl of a disc centrifuge, comprising:
an inner sleeve forming a longitudinally extending passageway, the inner sleeve having an elevated region at its top, the elevated region having an extended front end; and
an outer sleeve for supporting the inner sleeve along most of its length, the outer sleeve having a collar with an outermost edge at its top;
whereby when the inner sleeve is inserted into the outer sleeve, the elevated region of the inner sleeve extends past the collar of the outer sleeve and the extended front end of the elevated region extends towards the outermost edge of the outer sleeve collar.

2. The nozzle as claimed in claim 1, wherein the extended front end of the elevated region covers a substantial portion of the outer sleeve collar.

3. The nozzle as claimed in claim 2, wherein only a small portion of the outer sleeve collar remains uncovered by the extended front end.

4. The nozzle as claimed in claim 1, wherein the extended front end is a tapered wedge shape.

5. The nozzle as claimed in claim 1, whereby the collar of the outer sleeve and the extended from end of the elevated region of the inner sleeve are secured to one another so that there is little to no space therebetween.

6. The nozzle as claimed in claim 1, wherein the elevated region of the inner sleeve is made of the same material as the inner sleeve.

7. The nozzle as claimed in claim 1, wherein the elevated region and the inner sleeve are formed as an integral unit.

8. The nozzle as claimed in claim 1, wherein the extended front end and the collar form an angle greater than about 90°.

9. The nozzle as claimed in claim 8, wherein the angle is about 150° or greater.
